(19) United States
(12) Patent Application Publication
(10) Pub. No.: US 2011/0070477 A1
(43) Pub. Date: Mar. 24, 2011

(54) STACK TYPE BATTERY

(75) Inventors: Masayuki Fujiwara, Kasai-shi (JP); Yoshitaka Shinyashiki, Kobe-shi (JP); Hitoshi Maeda, Kobe-shi (JP); Atsuhiro Funahashi, Osaka (JP)

(73) Assignee: SANYO ELECTRIC CO., LTD., Osaka (JP)

(21) Appl. No.: 12/883,771

(22) Filed: Sep. 16, 2010

(30) Foreign Application Priority Data
Sep. 18, 2009 (JP) 2009-216330

(51) Int. Cl. H01M 10/02; H01M 10/052

(52) U.S. Cl. 429/152

(57) ABSTRACT

A penetrating portion (15P) is provided partially at a location in a positive electrode current collector terminal (15) to which positive electrode lead tabs (11) (electrode plate lead tabs) are joined, to form a current-collector-terminal-absent region (penetrating portion (15P)) and a current-collector-terminal-present region that are aligned in a perpendicular direction (a widthwise direction) to a connection direction of the positive electrode lead tabs (11). Only the plurality of the positive electrode lead tabs (11) are joined at a center weld point (32M) (first joining spot) in the current-collector-terminal-absent region, and the positive electrode lead tabs (11) are joined to the positive electrode current collector terminal 15 at each of left-side and right-side weld points 32L and 32R (second joining spot) in the current-collector-terminal-present region.

### BACKGROUND OF THE INVENTION

1. Field of the Invention

The present invention relates to stack type batteries, which have high capacity and high rate performance and are used for robots, electric vehicles, backup power sources and the like. More particularly, the invention relates to a high-capacity lithium-ion battery that has a large number of stacks requiring connection between a large number of electrode plate lead tabs and a current collector terminal, and that achieves uniform connection resistance between the electrode plates and the current collector terminal.

2. Description of Related Art

Power sources for robots and electric vehicle and backup power sources, for example, require high capacity and high rate performance. Lithium-ion batteries, which offer high energy density, have attracted attention as they meet such requirements.

The battery configurations of the lithium-ion batteries are broadly grouped into two types. One is what is called a spirally-wound type battery. It has an electrode assembly, enclosed in a battery case, and the electrode assembly comprises positive and negative electrode plates that are spirally wound together with separators interposed therebetween. The other one is what is called a stack type battery. It has a stacked electrode assembly enclosed in a battery case, and the stacked electrode assembly comprises positive electrode plates and negative electrode plates in a square shape that are stacked alternately together with separators interposed therebetween.

Of the two types of battery configurations, the stacked electrode assembly of the latter type of stack type battery has the following structure. A required number of sheet-like positive electrode plates, each having a positive electrode plate lead tab extending outward, and a required number of sheet-like negative electrode plates, each having a negative electrode plate lead tab extending outward, are stacked together with square-shaped separators having substantially the same shape as the negative electrode plates. The electrode plate lead tabs extending outward from the respective electrode plates are joined respectively to the positive and negative electrode current collector terminals.

### REFERENCES

### Patent Documents

[Patent Document 1] Japanese Published Unexamined Patent Application No. 2008-66170

[Patent Document 2] Japanese Published Unexamined Patent Application No. 2000-311665

[Patent Document 3] Japanese Published Unexamined Patent Application No. 2009-87611

In Patent Documents 1 and 2 (Japanese Published Unexamined Patent Application Nos. 2008-66170 and 2000-311665), a plurality of electrode plate lead tabs extending outward from the respective electrode plates are joined respectively to positive and negative electrode current collector terminals by ultrasonic welding so as to be stacked and overlapped one on the other. In the case of a high-capacity stack type battery that is to be charged and discharged at high rate, the number of stacks tends to be larger to achieve high capacity, and the thickness of the current collector terminals tends to be greater to pass a large current therethrough. This necessitates ultrasonic welding of a large number of electrode plate lead tabs each made of metal foil to the current collector terminal made of a thick metal plate. However, in this case, weldability of the welded portions between the metal foils and the metal plate tends to be poorer than that of the welded portions of the metal foils to each other, because of their thickness difference. When the weldability becomes poor, the connection resistance between each of the electrode plates and the current collector terminal becomes non-uniform, causing variations in the current values flowing into the respective electrode plates especially when used at high rate. As a consequence, uneven charge-discharge states arise and overdischarge and overcharge occur locally in the battery, deteriorating the cycle performance.

In the case of the spirally-wound type battery, the electrode assembly comprises one positive electrode plate and one negative electrode plate. Accordingly, in order to increase the battery capacity, it is only necessary to increase the lengths of the electrode plates to increase the number of windings, and it is unnecessary to increase the number of the electrode plates. Therefore, the variations in the current value, such as described above, do not occur easily. Even if variations occur in the currents flowing into the electrode plates, significant adverse effects do not arise eventually because each of the positive and negative electrode plates comprises only one electrode plate. On the other hand, in the case of the stack type battery, separate electrode plates are stacked on each other. Accordingly, when the number of the stacks is greater, variations in the resistance values at the connection parts tend to occur more easily, causing variations in the current values flowing into the electrode plates. As a consequence, a difference arises between the electrode plates that finish discharging early and the other electrode plates, degrading the cycle performance.

In Japanese Published Unexamined Patent Application No. 2009-87611 (Patent Document 3), the electrode plate lead tabs are welded and electrically connected to each other at a location different from the connection part with the current collector terminal, to prevent variations in the resistance values of the connection portions between the electrode plates and the current collector terminal. However, a problem of this structure is that the area of the welded portion tends to be large, increasing the size of the battery as a whole.

Accordingly, it is an object of the present invention to provide a stack type battery that can prevent variations in the connection resistance values between electrode plates and a current collector terminal, can inhibit the increase of the battery size resulting from the increase of the area of the joining portions, and can maintain the volumetric energy density to a desirable level.

In order to accomplish the foregoing and other objects, the present invention provides a stack type battery, comprising:

a plurality of positive electrode plates each having an electrode plate lead tab; a plurality of negative electrode plates each having an electrode plate lead tab; a plurality of separators; and positive and negative electrode current collector terminals, the positive and negative electrode plates being alternately stacked one on the other with the separators interposed therebetween, and a plurality of the electrode plate lead tabs being stacked and joined respectively to the positive and negative electrode current collector terminals, wherein

each of the current collector terminals has a penetrating portion, formed at a location thereof to which the electrode plate leads are joined, so as to form a current-collector-terminal-absent region and a current-collector-terminal-present region aligned along a direction perpendicular to a connection direction of the electrode plate lead tabs; and

only the plurality of electrode plate lead tabs are joined to each other at a first joining spot in the current-collector-terminal-absent region, and the electrode plate lead tabs are joined to a respective one of the current collector terminals at a second joining spot in the current-collector-terminal-present region.

In the present invention, the term “the connection direction of the electrode plate lead tabs” refers to a direction in which the electrode plate lead tabs extend outward from the electrode plates to the point at which they are connected to the current collector terminal.

The term “penetrating portion” is intended to include, for example, any of the following: one in which an end portion of a current collector terminal is cut away inwardly, one in which the corners of the current collector terminal are cut off, and one in which a hole (opening) is formed in the current collector terminal. Needless to say, one in which the current collector terminal is cut away entirely across its widthwise direction (a direction perpendicular to the connection direction of the electrode plate lead tabs) is equivalent to one in which the current collector terminal is divided into two parts or shortened in the longitudinal direction, so it does not serve as a penetrating portion. In other words, the penetrating portion is inevitably formed partially across a widthwise direction in the current collector terminal.

The term “current-collector-terminal-absent region” means a region in a current collector terminal in which the penetrating portion is provided so that the current collector terminal is missing and absent. The term “current-collector-terminal-present region” means a region in which the current collector terminal is present (i.e., the current collector terminal is not missing but is present) so as to be adjacent to the current-collector-terminal-absent region along a direction perpendicular to the connection direction of the electrode plate lead tabs. It should be noted that, as mentioned above, the penetrating portion is formed partially along a widthwise direction of the current collector terminal, and therefore, the current-collector-terminal-absent region and the current-collector-terminal-present region are formed inevitably so as to be aligned along a widthwise direction of the current collector terminal (i.e., the direction perpendicular to the connection direction of the electrode plate lead tabs).

In the configuration of the present invention, only the plurality of electrode plate lead tabs are joined at the first joining spot. As a result, a closed circuit is formed, and thereby the connection resistance is made uniform. Therefore, variations in the current values flowing into the electrode plates are not caused even during high-rate charge and discharge, and good cycle performance can be obtained.

Moreover, the first joining spot and the second joining spot are disposed respectively in the current-collector-terminal-absent region and the current-collector-terminal-present region aligned along the direction perpendicular to the connection direction of the electrode plate lead tabs. Therefore, the area of the joining portions constituting the first and second joining spots does not increase along the connection direction of the electrode plate lead tabs. As a result, the battery size does not increase, and the volumetric energy density is maintained at a desired level.

It is desirable that joining at at least one of the first joining spot and the second joining spot be effected by ultrasonic welding.

The just-mentioned joining may be effected by a method in which the subject members of the joining are mechanically joined, such as screw-fastening as well as swaging and thrust-and-press clamping, in which the subject members of the joining are deformed. By these methods as well, the advantageous effects of the present invention are exhibited, and the additional advantages are obtained that the joining work can be performed with a simple facility and that the fabrication of the battery can be performed correspondingly easily and at low cost. However, welding is more desirable because the resistance can be made more uniform.

Although it is possible to employ resistance welding, laser welding, and the like as the examples of the welding method, ultrasonic welding is particularly desirable from the viewpoint of welding strength.

When the joining at the first joining spot is effected by ultrasonic welding, the welding can be performed with a small output power because the welding is carried out for the thin electrode plate lead tabs are welded to each other (i.e., welding is carried out in the absence of the thick current collector terminal). As a result, deformation of the electrode plate lead tabs, resulting from the impact of the welding, can be minimized. Therefore, adhesion of the electrode plate lead tabs to each other is improved, and the connection resistance values can be made more uniform.

It is desirable that joining at at least one of the first joining spot and the second joining spot be effected at a plurality of points.

With the above-described configuration, the joining at the first joining spot and/or the second joining spot can be effected more reliably, and the connection resistance can be made more uniform.

It is desirable that at least one of the current collector terminals and the electrode plate lead tabs be bent in a direction perpendicular or substantially perpendicular to the connection direction of the electrode plate lead tabs.

With the above-described configuration, at least one of the electrode plate lead tabs and the current collector terminals is bent, and therefore the one of the electrode plate lead tabs and the current collector terminals is decreased in size correspondingly along the connection direction of the electrode plate lead tabs. As a result, the battery size is also decreased, and the volumetric energy density is improved further.

It is desirable that the stack type battery be a lithium-ion battery.

When a high-energy density lithium-ion battery is constructed by a stack type battery, the number of stacks tends to be greater to further increase the capacity. When the number of the stacks is greater, variations in the connection resistance tend to occur more easily. Therefore, the advantageous effects of the present invention can be exhibited more effectively.

It is desirable that the number of each of the positive electrode plates and the negative electrode plates stacked be 30 or greater.

When the number of each of the positive electrode plates and the negative electrode plates stacked is 30 or greater, the weldability of the joining portions of the current collector terminals and the electrode plate lead tabs tends to be poorer, so the advantageous effects of the present invention will be more significant.

According to the stack type battery of the present invention, the connection resistance between the electrode plates and the current collector terminals is made uniform, and the current values flowing into the electrode plates at the time of high-rate charge and discharge are also made uniform. As a result, good cycle performance can be obtained. Moreover, the area of the joining portions including the first and second joining spots does not increase. As a result, the battery size is not increased, and the volumetric energy density is kept at a desired level.

### BRIEF DESCRIPTION OF THE DRAWINGS

FIG. 1 shows portions of a stack type battery according to the present invention, wherein FIG. 1(a) is a plan view illustrating a positive electrode, FIG. 1(b) is a perspective view illustrating a separator, and FIG. 1(c) is a plan view illustrating a pouch-type separator in which the positive electrode is disposed;

FIG. 2 is a plan view illustrating a negative electrode plate used for the stack type battery according to the present invention;

FIG. 3 is an exploded perspective view illustrating a stacked electrode assembly used for the stack type battery according to the present invention;

FIG. 4 is a plan view illustrating the stacked electrode assembly used for the stack type battery according to the present invention;

FIG. 5 is a perspective view illustrating how positive and negative electrode lead tabs and positive and negative electrode current collector terminals are welded;

FIG. 6 is a plan view illustrating a positive electrode current collector terminal used for the stack type battery according to the present invention;

FIG. 7 is a plan view illustrating how positive electrode lead tabs and the positive electrode current collector terminal are welded;

FIG. 8 is a plan view illustrating how negative electrode lead tabs and the negative electrode current collector terminal are welded;

FIG. 9 is a perspective view illustrating how the positive and negative electrode lead tabs and the positive and negative electrode current collector terminals are bent;

FIG. 10 is a side view illustrating how the positive and negative electrode lead tabs and the positive and negative electrode current collector terminals are bent;

FIG. 11 is a front view illustrating how the positive and negative electrode lead tabs and the positive and negative electrode current collector terminals are bent;

FIG. 12 is a perspective view illustrating how a stacked electrode assembly is inserted in a battery case used for the stack type battery according to the present invention;

FIG. 13 is a partial plan view illustrating how positive electrode lead tabs and a positive electrode current collector terminal are welded in a stack type battery of a comparative example;

FIG. 14 is a plan view illustrating a current collector terminal in another example;

FIG. 15 is a plan view illustrating a current collector terminal in still another example; and

FIG. 16 is a plan view illustrating a current collector terminal in yet another example.

### DETAILED DESCRIPTION OF THE INVENTION

Hereinbelow, with reference to the drawings, the present invention is described in further detail based on certain embodiments and examples thereof. It should be construed, however, that the present invention is not limited to the following embodiments and examples, but various changes and modifications are possible without departing from the scope of the invention.

### Preparation of Positive Electrode

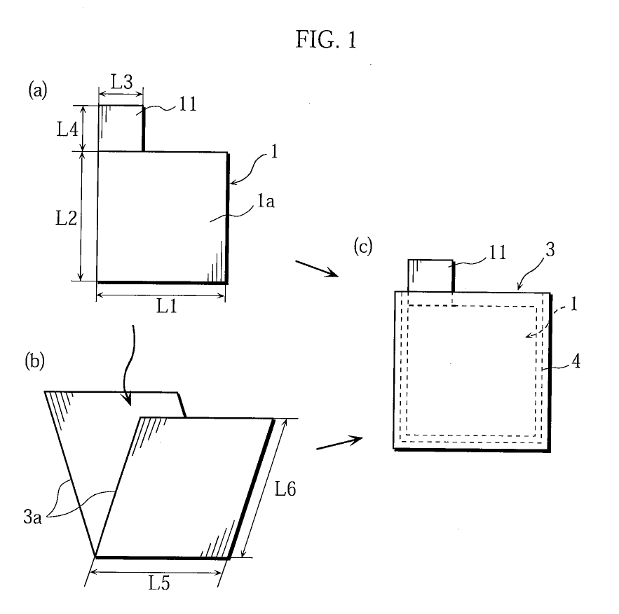

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector. Then, the material was dried to remove the solvent and compressed with rollers to a thickness of 0.1 mm. Thereafter, as illustrated in FIG. 1(a), it was cut into a rectangular shape having a width L1=95 mm and a height L2=115 mm, to prepare a positive electrode plate 1 having a positive electrode active material layer 1a on each side. Here, a positive electrode lead tab 11 was formed by allowing an active material uncoated portion in a rectangular shape having a width L3=30 mm and a height L4=20 mm to extend outward from one end portion (the left end portion in FIG. 1(a)) of one of the short sides (the upper side in FIG. 1(a)) of the positive electrode plate 1.

### Preparation of Negative Electrode

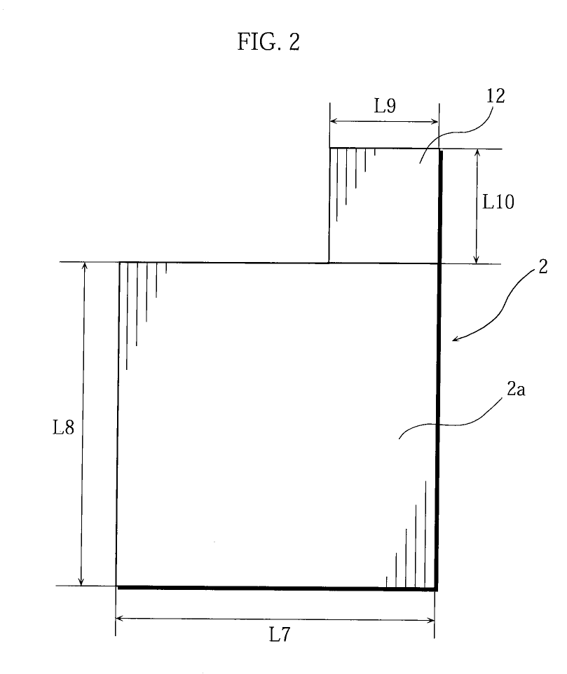

95 mass % of graphite powder as a negative electrode active material and 5 mass % of polyvinylidene fluoride as a binder agent were mixed with an NMP solution as a solvent to prepare a negative electrode slurry. Thereafter, the resultant negative electrode slurry was applied onto both sides of a copper foil (thickness: 10 μm) serving as a negative electrode current collector. Then, the material was dried to remove the solvent and compressed with rollers to a thickness of 0.08 mm. Thereafter, as illustrated in FIG. 2, it was cut into a rectangular shape having a width L7=100 mm and a height L8=120 mm, to prepare a negative electrode plate 2 having a negative electrode active material layer 2a on each side. Here, a negative electrode lead tab 12 was formed by allowing an active material uncoated portion in a rectangular shape having a width L9=30 mm and a height L10=20 mm to extend outward from one end portion (the right end portion in FIG. 2) of one of the short sides (the upper side in FIG. 2) of the negative electrode plate 2.

Preparation of Pouch-Type Separator in which the Positive Electrode Plate is Disposed

The positive electrode plate 1 was disposed between two square-shaped polypropylene (PP) separators 3a (thickness: 30 μm) each having a width L5=100 mm and a height L6=120 mm as illustrated in FIG. 1(b). Thereafter, as illustrated in FIG. 1(c), the peripheral portions of the separators 3a were thermally sealed at a sealing part 4, to prepare a pouch-type separator 3, in which the positive electrode plate 1 is accommodated.

### Preparation of Stacked Electrode Assembly

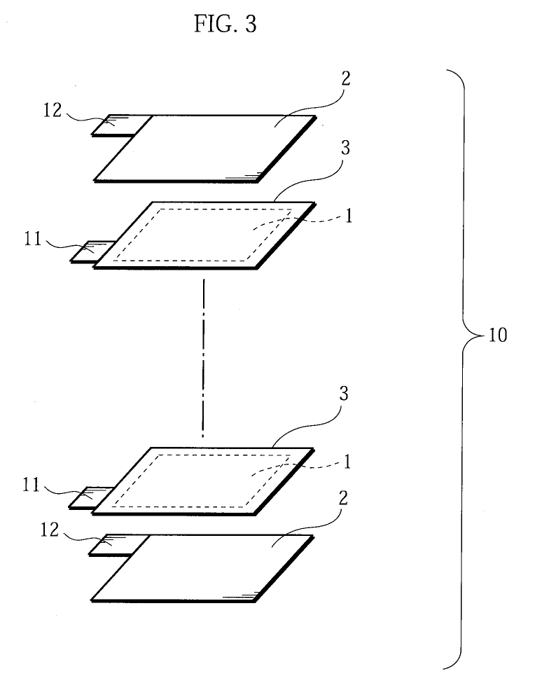

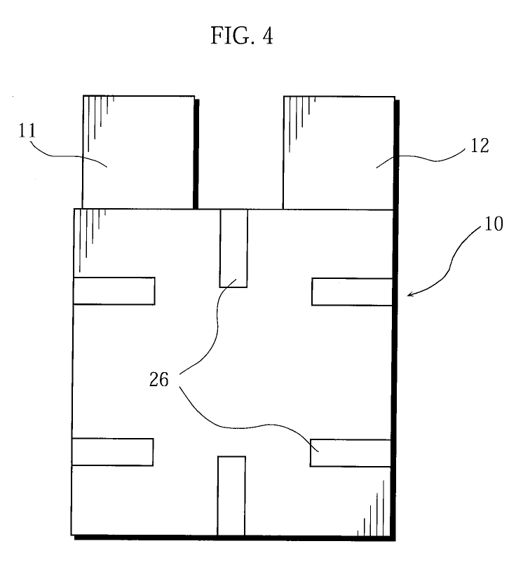

50 sheets of the pouch-type separators 3 in each of which the positive electrode plate 1 was disposed and 51 sheets of the negative electrode plates 2 were prepared, and the pouch-type separators 3 and the negative electrode plates 2 were alternately stacked one on the other, as illustrated in FIG. 3. Both top and bottom faces of the stack were the negative electrode plates 2. Subsequently, as illustrated in FIG. 4, the top and bottom faces of the stack were connected by insulating tapes 26 for retaining its shape. Thus, a stacked electrode assembly 10 was obtained.

### Welding of Current Collectors

As illustrated in FIG. 5, a positive electrode current collector terminal 15 made of an aluminum plate having a width of 30 mm and a thickness of 0 5 mm and a negative electrode current collector terminal 16 made of a copper plate having a width of 30 mm and a thickness of 0.5 mm were joined to the respective end portions of the stacked positive electrode lead tabs 11 and the stacked negative electrode lead tabs 12 by ultrasonic welding.

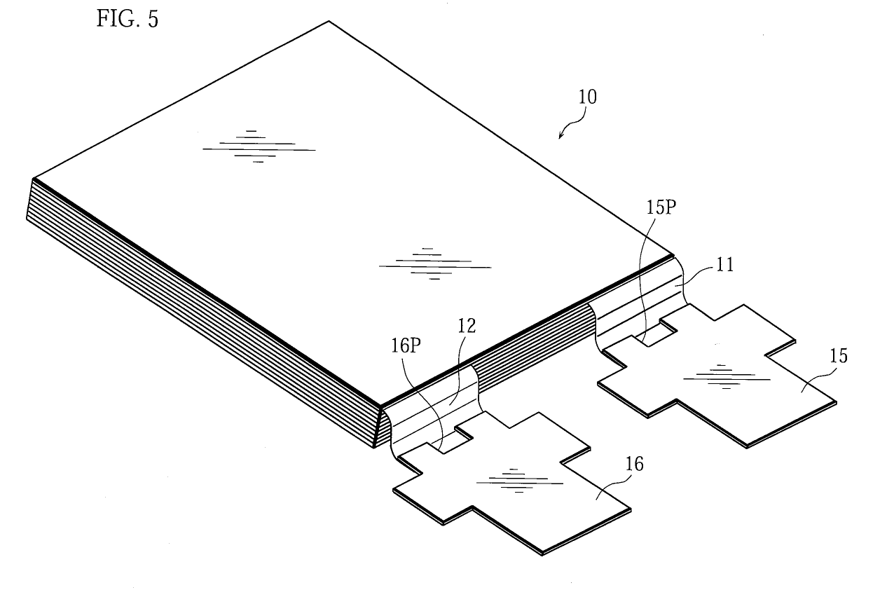

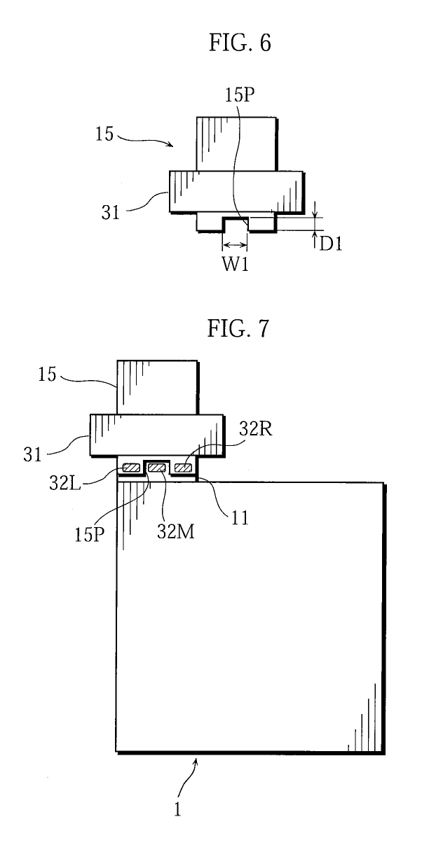

In this process, as illustrated in FIG. 6, a penetrating portion 15P having a width W1=10 mm and a depth D1=5 mm was formed by cutting away a center portion of one peripheral edge portion of the positive electrode current collector terminal 15 inwardly in a rectangular shape. As illustrated in FIG. 7, while the peripheral edge portion of the positive electrode current collector terminal 15 in which the penetrating portion 15P was formed was kept overlapped with the positive electrode lead tabs 11, the 50 sheets of the positive electrode lead tabs 11 only were first joined by ultrasonic welding at a weld point 32M (hereinafter referred to as the “center weld point”) located in the penetrating portion 15P, and next, the 50 sheets of the positive electrode lead tabs 11 and the positive electrode current collector terminal 15 were joined to each other by ultrasonic welding at a weld point 32L (hereinafter referred to as a “left-side weld point”) adjacently on one side (on the left side in FIG. 5) along the widthwise direction of the center weld point 32M and at a weld point 32R (hereinafter referred to as a “right-side weld point”) adjacently on the other side (on the right side in FIG. 5).

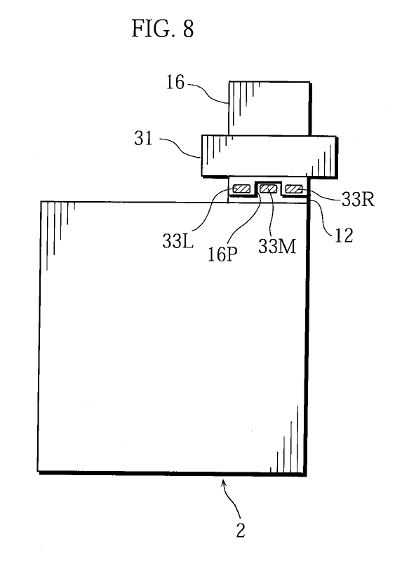

In addition, as illustrated in FIG. 8, a penetrating portion 16P was formed also in the negative electrode current collector terminal 16 in the same manner as in the case of the positive electrode current collector terminal 15. The 51 sheets of the negative electrode lead tabs 12 only were joined by ultrasonic welding at a center weld point 33M, and next, the 51 sheets of the negative electrode lead tabs 12 and the negative electrode current collector terminal 16 were joined to each other at a left-side weld point 33L and a right-side weld point 33R by ultrasonic welding.

The conditions of the welding are shown in Table 1 below.

TABLE 1

| | Positive electrode side | | Negative electrode side | |
|---|---|---|---|---|
| | (Both the lead tabs and the current | | (Both the lead tabs and the current | |
| | collector terminal made of aluminum) | | collector terminal made of copper) | |
| | | Second joining spot | | Second joining spot |
| | | (Positive electrode | | (Negative electrode |
| | First joining spot | lead tabs + Positive | First joining spot | lead tabs + Negative |
| | (Positive electrode | electrode current | (Negative electrode | electrode current |
| | lead tabs only) | collector terminal) | lead tabs only) | collector terminal) |
| Number | 1 | 2 × each side | 1 | 2 × each side |
| of weld | | | | |
| point | | | | |
| Weld area | 8 mm × 3 mm/spot | | | |
| Pressure | 0.15′ MPa | | | |
| Frequency | 20 kHz | | | |
| Time | 0.3 seconds | | | |
| Energy | 30 J | 50 J | 30 J | 50 J |
| amount | | | | |

It should be noted that reference numeral 31 shown in FIGS. 6 through 8 (and other figures) denotes a plastic sealing material (adhesive material) formed so as to firmly adhere in a belt-like shape to each of the positive electrode current collector terminal 15 and the negative electrode current collector terminal 16 along the widthwise direction in order to ensure hermeticity in heat-sealing a later-described battery case 18.

### Shaping of Current Collectors

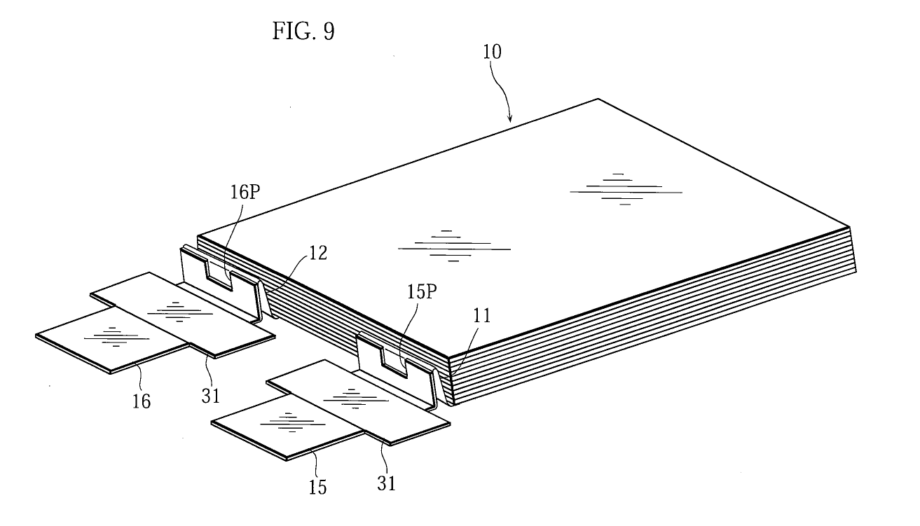

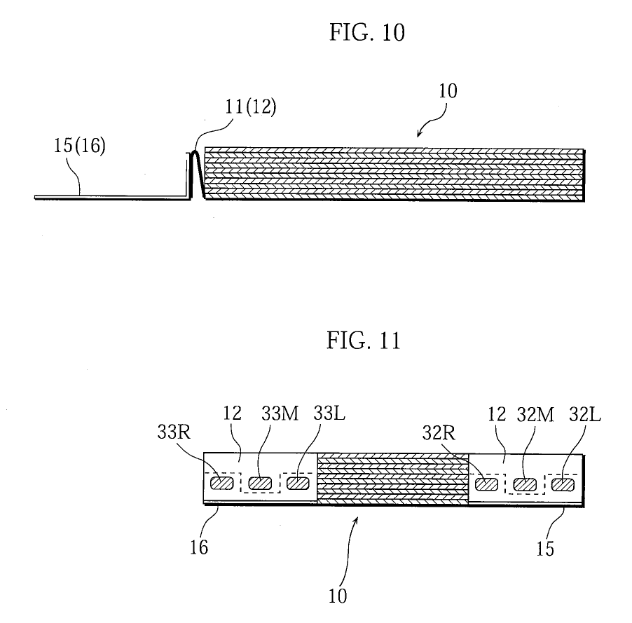

As illustrated in FIGS. 9 through 11, the positive electrode lead tabs 11 and the negative electrode lead tabs 12 were bent about 90 degrees toward one face side (upward in FIG. 8) at their base edge positions (the end edges thereof located on one short side of the positive electrode plates 1 and the negative electrode plates 2), and the positive and negative electrode current collector terminals 15 and 16 were also bent about 90 degrees toward one face side (upward in FIG. 8) at positions nearer the foremost ends than the penetrating portions 15P and 16P. In addition, the positive electrode lead tabs 11 and the negative electrode lead tabs 12 were folded over at the locations along the peripheral edge portions of the positive and negative electrode current collector terminals 15 and 16 in which the penetrating portions 15P and 16P were formed, which were located in the middle of the above-described positions. Thus, the positive and negative electrode current collector terminals 15, 16 and the positive and negative electrode lead tabs 11, 12 were configured to be bent in a direction substantially perpendicular to the connection direction of the positive and negative electrode lead tabs 11, 12.

### Placing the Electrode Assembly in Battery Case

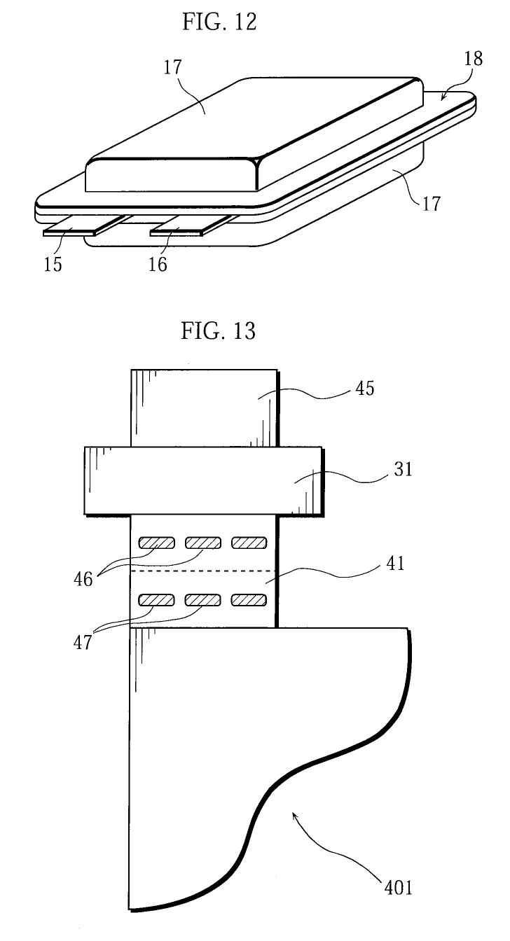

As illustrated in FIG. 12, the stacked electrode assembly 10 was inserted into a battery case 18, which had been formed of two laminate films 17 in advance so that the stacked electrode assembly 10 could be placed therein. Then, one side of the battery case in which the positive electrode current collector terminal 15 and the negative electrode current collector terminal 16 were present was thermally bonded so that only the positive electrode current collector terminal 15 and the negative electrode current collector terminal 16 would protrude from the battery case 18, and also, two sides of the remaining three sides of the battery case were thermally bonded.

### Filling Electrolyte Solution, and Sealing

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case 18 from the remaining one side of the battery case that was not yet thermally bonded. Lastly, the one side that had not been thermally bonded was thermally bonded. Thus, a stack type battery was prepared.

### EXAMPLES

### EXAMPLE

A stack type battery fabricated in the same manner as described in the foregoing embodiment was used as the stack type battery of this example.

The stack type battery fabricated in this manner is hereinafter referred to as Battery A of the invention.

### COMPARATIVE EXAMPLE

As illustrated in FIG. 13, no penetrating portion was provided in the positive electrode current collector terminal 45, and 50 sheets of positive electrode lead tabs 41 were joined to a positive electrode current collector terminal 45 by ultrasonic welding at three weld points 46 aligned along a widthwise direction in one peripheral edge portion of the positive electrode current collector terminal 45. In addition, the 50 sheets of the positive electrode lead tabs 41 only are joined to each other by ultrasonic welding at three weld points 47 located intermediate the positive electrode plates 401 and the positive electrode current collector terminal 45 and aligned along a widthwise direction. Meanwhile, a negative electrode current collector terminal and negative electrode lead tabs were joined to each other (not shown in the figure) by the same joining structure as the just-mentioned joining structure. The positive and negative electrode current collector terminals and the positive and negative electrode lead tabs were not bent. Except for the just-described points, a stack type battery was fabricated in the same manner as in the case of the foregoing Battery A of the invention.

The stack type battery fabricated in this manner is hereinafter referred to as Comparative Battery Z.

### Advantages of the Present Invention Battery

The foregoing battery A of the invention is a stack type battery comprising: 50 sheets of the positive electrode plates 1; 51 sheets of the negative electrode plates 2; the pouch-type separators 3; positive and negative electrode current collector terminals; and 50 sheets of the positive electrode lead tabs 11 and 51 sheets of the negative electrode lead tabs 12 extending outward respectively from the positive and negative electrode plates 1, 2, each of the positive and negative electrode lead tabs being stacked and joined to a respective one of the positive and negative electrode current collector terminals, and the positive electrode plates and the negative electrode plates alternately stacked one on the other with the pouch-type separators 3 interposed therebetween. Each of the positive and negative electrode current collector terminals 15, 16 has a penetrating portion 15P or 16P provided partially at a location to which the positive or negative electrode lead tab 11, 12 is joined. Thereby, a rectangular-shaped current-collector-terminal-absent region, in which the positive or negative electrode current collector terminal 15, 16 is missing and absent, is formed, and rectangular-shaped current-collector-terminal-present regions, in which the positive or negative electrode current collector terminal 15 or 16 is present, are formed adjacent to and at the sides of the current-collector-terminal-absent region (the penetrating portion 15P or 16P), so that they are aligned in a direction perpendicular to the connection direction of the positive or negative electrode lead tab 11, 12 (i.e., along the width L3 or L9 direction). In the current-collector-terminal-absent region, the 50 sheets and the 51 sheets of the positive and negative electrode lead tabs 11, 12 only are joined to each other at the first joining spot, which includes the center weld points 32M, 33M, and in the current-collector-terminal-present region, the positive and negative electrode lead tabs 11, 12 are joined respectively to the positive and negative electrode current collector terminals 15, 16 at the second joining spot, which includes the left-side weld points 32L, 33L and the right-side weld points 32R, 33R.

In the configuration of the foregoing battery A of the invention, the 50 sheets and 51 sheets, respectively, of the positive and negative electrode lead tabs 11, 12 only are joined to each other respectively at the center weld points 32M and 33M, each of which serves as the first joining spot. Thereby, a closed circuit is formed, so that the connection resistance is made uniform. Therefore, variations are not caused in the current value flowing into each one of the positive and negative electrode plates 1 and 2 even during high-rate charge and discharge, and good cycle performance can be obtained.

The center weld points 32M, 33M, each serving as the first joining spot, and left-side weld points 32L, 33L as well as the right-side weld points 32R, 33R, each serving as the second joining spot, are disposed respectively in the current-collector-terminal-absent region and the current-collector-terminal-present region that are aligned along a direction perpendicular to the connection direction of the positive and negative electrode lead tabs 11, 12, i.e., along the directions of the widths L3 and L9. Therefore, the area of the joining portions constituted by the first and second joining spots, i.e., the occupied area by the center weld points 32M, 33M, the left-side weld points 32L, 33L, and the right-side weld points 32R, 33R, is not increased along the connection direction of the positive and negative electrode lead tabs 11 and 12, and is kept at the minimum. As a result, the battery size is not increased, and the volumetric energy density is kept at a desired level. In contrast, in Comparative Battery Z, the three weld points 46 at which the positive electrode lead tabs 41 and the positive electrode current collector terminal 45 are joined to each other and the three weld points 47 at which the positive electrode lead tabs 41 only are joined to each other are disposed so as to be aligned so as to form two lines along a widthwise direction. Consequently, the occupied area by the weld points 46 and 47 is increased along the connection direction of the positive electrode lead tabs 41, and the occupied area is greater than in the case of Battery A of the invention.

In addition, the joining at both the center weld points 32M, 33M, each serving as the first joining spot, and the left-side weld points 32L, 33L and the right-side weld points 32R, 33R, each serving as the second joining spot, is effected by ultrasonic welding. The joining at the first joining spot and/or the second joining spot may be effected by a mechanical joining method, such as screw-fastening and the like as well as swaging, thrust-and-press clamping, and the like. By these methods, the additional advantages are obtained that the joining work can be performed with a simple facility and that the fabrication of the battery can be performed correspondingly easily and at low cost. However, Battery A of the invention employs welding, and therefore, the resistance is made more uniform. Although it is possible to employ resistance welding, laser welding, and the like as the welding method, Battery A of the invention employs ultrasonic welding. Therefore, Battery A of the invention is particularly desirable from the viewpoint of welding strength.

Furthermore, at the center weld points 32M and 33M, each serving as the first joining spot, the thin positive and negative electrode lead tabs 11, 12 are welded by ultrasonic welding while the thick positive and negative electrode current collector terminals 15, 16 are absent. This allows the welding at the first joining spot to be effected with a smaller output power, an energy amount of 30J, than the energy amount required at the second joining spot, 50 J, as shown in Table 1. As a result, the positive and negative electrode lead tabs 11, 12 are inhibited from the deformation resulting from the impact at the time of the welding. Therefore, adhesion of the positive and negative electrode lead tabs 11, 12 to each other is improved, and the connection resistance values are made more uniform.

In addition, the joining at the second joining spot is effected at a plurality of points (two points), each of the left-side weld points 32L, 33L and each of the right-side weld points 32R, 33R. Therefore, the joining at the second joining spot is made more reliable, and the connection resistance is made more uniform.

Moreover, the positive and negative electrode lead tabs 11, 12 and the positive and negative electrode current collector terminals 15, 16 are bent in a direction substantially perpendicular to the connection direction of the positive and negative electrode lead tabs 11, 12, so they are correspondingly reduced in size along the connection direction of the positive and negative electrode lead tabs 11, 12. Accordingly, the battery size is correspondingly reduced, and the volumetric energy density is improved further. On the other hand, in Comparative Battery Z, the positive and negative electrode current collector terminals and the positive and negative electrode lead tabs are not bent, so the lengths of the positive and negative electrode current collector terminals and the positive and negative electrode lead tabs that extend outward are greater than in the case of Battery A of the invention. Accordingly, the battery size is greater, and the volumetric energy density is poorer.

Furthermore, Battery A of the invention is constructed by a lithium-ion battery in the form of stack type battery, so the number of stacks is large with the number of the positive electrode plates 1 being 50 and the number of the negative electrode plates 2 being 51. For this reason, variations in the connection resistance tend to occur easily with the conventional configurations. Thus, Battery A of the invention has a configuration such that the advantageous effects of the present invention, such as uniformization of the connection resistance and reduction in the battery size, are exhibited more significantly.

What is more, when the number of each of the positive electrode plates and the negative electrode plates stacked is 30 or greater, the weldability of the joining portions of the current collector terminals and the electrode plate lead tabs tends to be particularly poorer, so the advantageous effects of the present invention, such as the uniformization of the connection resistance and the reduction in the battery size, are exhibited more significantly.

### Other Embodiments

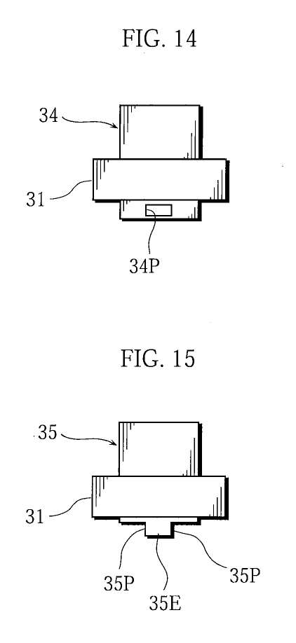

(1) In the foregoing battery A of the invention. the the penetrating portions 15P and 16P that are cut away inwardly in a rectangular shape (hereinafter also referred to as “inwardly cut-away penetrating portions”) are formed in the positive and negative electrode current collector terminals 15 and 16. However, it is also possible to employ other shapes of the penetrating portions, such as a penetrating portion 34P in a hole-like shape as illustrated in FIG. 14 (hereinafter also referred to as a “hole-like penetrating portion”), and penetrating portions 35P such that the corners are cut off as illustrated in FIG. 15 (hereinafter also referred to as “corner-cutoff penetrating portions”).

The hole-like penetrating portion 34P shown in FIG. 14 is formed by making a hole (opening) in a rectangular shape (in a horizontally oriented rectangular shape) at the center of one peripheral edge portion of the current collector terminal 34. Electrode plate lead tabs are joined to the current collector terminal 34 in which the hole-like penetrating portion 34P is formed, in the same manner as in the case of the positive and negative electrode current collector terminals 15 and 16 of Battery A of the invention, in which the inwardly cut-away penetrating portions 15P and 16P are formed.

In this case, by providing the hole-like penetrating portion 34P, a current-collector-terminal-absent region in a rectangular shape, in which the current collector terminal 34 is missing and absent, is formed at the center of the current collector terminal, and current-collector-terminal-present regions in a rectangular shape, in which the current collector terminal 34 is present, are formed adjacent to and at the sides of the current-collector-terminal-absent region (i.e., the hole-like penetrating portion 34P), so that the current-collector-terminal-absent region and the current-collector-terminal-present regions are aligned along a direction perpendicular to the connection direction of the electrode plate lead tabs (along the widthwise direction). A plurality of the electrode plate lead tabs only are joined at a first joining spot in the current-collector-terminal-absent region (the hole-like penetrating portion 34P), which is located at the center, and the electrode plate lead tabs are joined to the current collector terminal 34 at second joining spots in the current-collector-terminal-present regions, which are located at the sides of the current-collector-terminal-absent region.

The corner-cutoff penetrating portions 35P shown in FIG. 15 are formed by cutting off two corner portions of one peripheral edge portion of the current collector terminal 34, i.e., a pair of the corner portions that are next to each other in a rectangular shape (in a horizontally oriented rectangular shape). When joining electrode plate lead tabs to a current collector terminal 35 in which the corner-cutoff penetrating portions 35P are formed, a second joining spot is positioned in a protruding portion 35E formed at the center between the corner-cutoff penetrating portions 35P at the sides, and first joining spots are positioned in the corner-cutoff penetrating portions 35P that are adjacent to and at the sides of the second joining spot along a widthwise direction. First, joining is performed at the first joining spots at the sides and thereafter joining is performed at the second joining spot located at the center.

In this case, by providing the corner-cutoff penetrating portions 35P, current-collector-terminal-absent regions in a rectangular shape, in which the current collector terminal 35 is missing and absent, are formed in both corner portions, and a current-collector-terminal-present region (i.e., the protruding portion 35E) in a rectangular shape, in which the current collector terminal 35 is present, is formed adjacent to the center sides of the current-collector-terminal-absent regions (i.e., the corner-cutoff penetrating portions 35P) on both sides, in such a manner that the current-collector-terminal-absent regions and the current-collector-terminal-present region are aligned along a direction perpendicular to the connection direction of the electrode plate lead tabs (along the widthwise direction). A plurality of the electrode plate lead tabs only are joined at the first joining spots in the current-collector-terminal-absent regions (the corner-cutoff penetrating portions 35P), which are located at the sides, and the electrode plate lead tabs are joined to the current collector terminal 35 at the second joining spot in the current-collector-terminal-present region (the protruding portion 35E), which is located at the center.

In any case of the inwardly cut-away penetrating portions 15P, 16P, the hole-like penetrating portion 34P, and the corner-cutoff penetrating portions 35P, electrode plate lead tabs and a thick current collector terminal are joined at the second joining spot. Therefore, if the joining is firstly performed at the second joining spot, it will become difficult to join only the electrode plate lead tabs at the first joining spot. For this reason, first, the electrode plate lead tabs only are joined to each other at the first joining spot, and thereafter, the current collector terminal and the electrode plate lead tabs are joined to each other at the second joining spot.

Among the inwardly cut-away penetrating portions 15P, 16P, the hole-like penetrating portion 34P, and the corner-cutoff penetrating portions 35P, the inwardly cut-away penetrating portions 15P, 16P and the corner-cutoff penetrating portions 35P show nearly the same degree of weldability, while the hole-like penetrating portion 34P shows slightly poorer weldability. From the viewpoint of formability (processability), the inwardly cut-away penetrating portions 15P, 16P is most outstanding, followed by the corner-cutoff penetrating portions 35P, and then by the hole-like penetrating portion 34P.

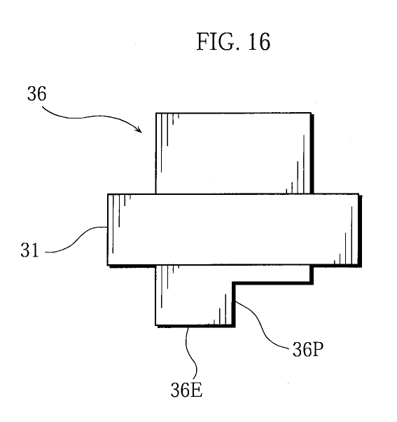

(2) In the configurations of the inwardly cut-away penetrating portions 15P, 16P, the hole-like penetrating portion 34P, and the corner-cutoff penetrating portions 35P, one or two current-collector-terminal-absent regions and respectively two or one current-collector-terminal-present region, three regions in total, are disposed so as to be aligned in one row along a widthwise direction. However, as illustrated in FIG. 16, it is possible to employ a configuration in which one current-collector-terminal-absent region and one current-collector-terminal-present region, two regions in total, are disposed so as to be aligned along a widthwise direction. In the example shown in the figure, a penetrating portion 36P is formed in such a manner that a half portion of one side of one peripheral edge portion in a current collector terminal 36 is cut away in a rectangular shape (in a horizontally oriented rectangular shape), and a protruding portion 36E is formed adjacent to the penetrating portion 36P, so that the end portion as a whole is shaped in a hook-like shape. A first joining spot is located in the penetrating portion 36P, and a second joining spot is located on the protruding portion 36E so as to be adjacent to and at a side of the first joining spot along a widthwise direction. Although this configuration can reduce the number of weld points, it has the drawback that the arrangement of the current-collector-terminal-absent region (the first joining spot) and the current-collector-terminal-present region (the second joining spot) becomes horizontally asymmetrical and uneven. On the other hand, in all the configurations of the inwardly cut-away penetrating portions 15P, 16P, the hole-like penetrating portion 34P, and the corner-cutoff penetrating portions 35P, the current-collector-terminal-absent region and the current-collector-terminal-present region are arranged horizontally symmetrically, so these are more preferable from the viewpoint of uniformity.

(3) In the foregoing battery A of the invention, the positive electrode current collector terminal 15 is made of an aluminum plate and the negative electrode current collector terminal 16 is made of a copper plate. However, each of the current collector terminals may be made of a nickel plate. When both the current collector terminals are made of the same material, manufacturing costs of the battery can be reduced. In this case, different kinds of metals need to be welded to each other (note that the positive electrode current collector tabs 11 are made of aluminum while the negative electrode current collector tabs 12 are made of copper), weldability of the weld portions tends to worsen, and the problem of variations in the connection resistance values between the current collector terminals and the electrode plates becomes more conspicuous. Therefore, the configuration of the present invention is particularly useful in this case.

(4) The positive electrode active material is not limited to lithium cobalt oxide. Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.

(5) Other than graphite such as natural graphite and artificial graphite, various materials may be employed as the negative electrode active material, as long as the material is capable of intercalating and deintercalating lithium ions. Examples include coke, tin oxides, metallic lithium, silicon, and mixtures thereof.

(6) The electrolyte is not limited to that shown in the example above, and various other substances may be used. Examples of the lithium salt include LiBF₄, LiPF₆, LiN(SO₂CF₃)₂, LiN(SO₂C₂F₅)₂, and LiPF_{6-X}(CₙF₂ₙ₊₁)_{X} (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte. The types of the solvents are not particularly limited to EC and MEC mentioned above, and examples of the preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

The present invention is suitably applied to, for example, power sources for high-power applications, such as backup power sources and power sources for the motive power incorporated in robots and electric automobiles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A stack type battery comprising:
a plurality of positive electrode plates each having an electrode plate lead tab; a plurality of negative electrode plates each having an electrode plate lead tab; a plurality of separators; and positive and negative electrode current collector terminals, the positive and negative electrode plates being alternately stacked one on the other with the separators interposed therebetween, and a plurality of the electrode plate lead tabs being stacked and joined respectively to the positive and negative electrode current collector terminals, wherein
each of the current collector terminals has a penetrating portion, provided partially at a location thereof to which the electrode plate lead tabs are joined, so as to form a current-collector-terminal-absent region and a current-collector-terminal-present region aligned along a direction perpendicular to a connection direction of the electrode plate lead tabs; and
only the plurality of electrode plate lead tabs are joined to each other at a first joining spot in the current-collector-terminal-absent region, and the electrode plate lead tabs are joined to a respective one of the current collector terminals at a second joining spot in the current-collector-terminal-present region.

2. The stack type battery according to claim 1, wherein joining at at least one of the first joining spot and the second joining spot is effected by ultrasonic welding.

3. The stack type battery according to claim 1, wherein joining at at least one of the first joining spot and the second joining spot is effected at a plurality of points.

4. The stack type battery according to claim 1, wherein joining at at least one of the first joining spot and the second joining spot is effected at a plurality of points.

5. The stack type battery according to claim 1, wherein at least one of the current collector terminals and the electrode plate lead tabs is bent in a direction perpendicular or substantially perpendicular to the connection direction of the electrode plate lead tabs.

6. The stack type battery according to claim 2, wherein at least one of the current collector terminals and the electrode plate lead tabs is bent in a direction perpendicular or substantially perpendicular to the connection direction of the electrode plate lead tabs.

7. The stack type battery according to claim 3, wherein at least one of the current collector terminals and the electrode plate lead tabs is bent in a direction perpendicular or substantially perpendicular to the connection direction of the electrode plate lead tabs.

8. The stack type battery according to claim 1, being a lithium-ion battery.

9. The stack type battery according to claim 2, being a lithium-ion battery.

10. The stack type battery according to claim 3, being a lithium-ion battery.

11. The stack type battery according to claim 4, being a lithium-ion battery.
